(19) United States
(12) Patent Application Publication
(10) Pub. No.: US 2026/0346850 A1
(43) Pub. Date: Nov. 5, 2026

(54) ACTUATOR PREDICTION FOR TRANSMISSION INTERVENTION TIMING AND AMPLITUDE

(71) Applicant: JAGUAR LAND ROVER LIMITED, Warwickshire (GB)

(72) Inventors: Romain LACROISILLE, Whitley, Coventry, Warwickshire (GB); Olivier ROQUES, Whitley, Coventry, Warwickshire (GB); Gareth JONES, Whitley, Coventry, Warwickshire (GB); Giuseppe FAVORITO, Whitley, Coventry, Warwickshire (GB); David PARRY, Whitley, Coventry, Warwickshire (GB)

(21) Appl. No.: 19/484,938

(22) PCT Filed: May 14, 2024
(86) PCT No.: PCT/EP2024/063230

§ 371 Date: Nov. 17, 2025

(30) Foreign Application Priority Data
May 17, 2023 (GB) 2307324.0

(51) Int. Cl. B60W 30/19; B60W 10/06; B60W 50/00; B60W 50/08

(52) U.S. Cl. CPC B60W 30/19; B60W 10/06; B60W 50/087; B60W 2050/0014; B60W 2710/0666; B60W 2710/083

(57) ABSTRACT

Aspects of the present invention relate to a control system, a vehicle, a method, and computer readable instructions. The control system is suitable for managing the torque of a vehicle. The control system comprises one or more controllers, and is configured to receive, at the one or more controllers, current torque availability data for each of a plurality of torque actuators of a propulsion system of the vehicle, the torque availability data representative of an amount of torque available for supply by the respective torque actuator of the propulsion system of the vehicle. The control system is further configured to receive, at the one or more controllers, a torque intervention request to either increase or decrease the torque supplied by the propulsion system of the vehicle; and to generate, by the one or more controllers, a predicted torque profile of the torque intervention request. The control system is then configured to predict, by the one or more controllers, one or more torque actuators of the plurality of torque actuators to be used in the torque intervention, the prediction being based upon the predicted torque profile and the torque availability data of each of the one or more torque actuators. The torque intervention request can then be adjusted based upon the predicted one or more torque actuators of the plurality of torque actuators; and implemented to increase or decrease the torque supplied by the propulsion system of the vehicle.

### TECHNICAL FIELD

The present disclosure relates to a control system for managing transmission torque interventions of a vehicle. Aspects of the invention relate to a control system and to a method for managing such interventions.

### BACKGROUND

It is known to provide systems in vehicles that provide torque from a powertrain, or propulsion system, of the vehicle to drive the vehicle. Conventionally, the transmission of a vehicle may receive a request to change the torque supplied by the propulsion system of the vehicle when the vehicle is in motion. Such requests to change the torque supplied by the propulsion system may be described as being a request for torque intervention, and may occur as a consequence of, for example, a gear shift. However, if the amount of torque available for supply from the propulsion system is inadequate to meet the amount of torque requested in the requested torque intervention, then the gear shift quality may be degraded. It is an aim of the present invention to address one or more of these disadvantages.

### SUMMARY OF THE INVENTION

According to an aspect of the present invention there is provided a control system for managing the torque of a vehicle, the control system comprising one or more controllers, and wherein the control system is configured to: receive, at the one or more controllers, current torque availability data for each of a plurality of torque actuators of a propulsion system of the vehicle, the torque availability data representative of an amount of torque available for supply by the respective torque actuator of the propulsion system of the vehicle within a predetermined time period; receive, at the one or more controllers, a torque intervention request to either increase or decrease the torque supplied by the propulsion system of the vehicle during the predetermined time period; generate, by the one or more controllers, a predicted torque profile of the torque intervention request; and predict, by the one or more controllers, one or more torque actuators of the plurality of torque actuators to be used in the torque intervention during the predetermined time period, the prediction being based upon the predicted torque profile and the torque availability data of each of the one or more torque actuators.

This aspect of the present invention may also include the control system being further configured to: adjust, by the one or more controllers, the torque intervention request based upon the predicted one or more torque actuators of the plurality of torque actuators.

This aspect of the present invention may also include the control system being further configured to: implement, by the one or more controllers, the adjusted torque intervention request to increase or decrease the torque supplied by the propulsion system of the vehicle during the predetermined time period.

In this way, the control system is able to implement a torque intervention (e.g. a gear shift) that more closely reflects the torque that is available for supply by the torque actuators of the powertrain of the vehicle. As a result, the quality of a subsequent torque intervention (e.g. gear shift) and the drivability of the vehicle is improved, or maintained, compared with a torque intervention that requests more torque than the powertrain is currently able to provide (i.e. the powertrain under-delivering torque during a torque intervention).

Optionally, the one or more controllers comprises a first control module and a second control module, and where the first control module is configured to receive the torque availability data and the torque intervention request, generate the predicted torque profile of the torque intervention request; and predict the one or more torque actuators of the plurality of torque actuators based on the predicted torque profile and the torque availability data of each of the one or more torque actuators; and the second control module is configured to adjust the torque intervention request based upon the predicted one or more torque actuators, and implement the adjusted torque intervention request.

Optionally, the torque availability data for each of the plurality of torque actuators comprises at least one of an upper limit of the torque available that can be supplied by each of the plurality of torque actuators during the predetermined time period, and a lower limit of the torque available that can be supplied by each of the plurality of torque actuators during the predetermined time period.

Optionally, the predicting of the one or more torque actuators of the plurality of torque actuators comprises determining, for each of the one or more torque actuators, that the predicted torque profile is at least one of:

less than the upper limit of the torque available during the predetermined time period; and greater than the lower limit of the torque available during the predetermined time period.

Optionally, the predicting of the one or more torque actuators of the plurality of torque actuators comprises determining, for each of the one or more torque actuators, that the predicted torque profile is at least one of:
greater than the upper limit of the torque available during the predetermined time period by less than a predetermined relative amount, or less than the lower limit of the torque available during the predetermined time period by less than a predetermined relative amount.

Optionally, the predicting, by the first control module, the one or more torque actuators of the plurality of torque actuators comprises one of: determining that the predicted torque profile is greater than the upper limit of the torque available during the predetermined time period for a first torque actuator of the plurality of torque actuators; determining that a sum of the upper limit of the torque available during the predetermined time period for the first torque actuator and the upper limit of the torque available during the predetermined time period for a second torque actuator of the plurality of torque actuators of the plurality of torque actuators is greater than the predicted torque profile; and predicting the first and second torque actuators as the predicted one or more torque actuators; or determining that the predicted torque profile is less than the lower limit of the torque available during the predetermined time period for a first torque actuator of the plurality of torque actuators; determining that the sum of the lower limit of the torque available during the predetermined time period for the first torque actuator and the lower limit of the torque available during the predetermined time period for a second torque actuator of the plurality of torque actuators of the plurality of torque actuators is less than the predicted torque profile; and predicting the first and second torque actuators as the predicted one or more torque actuators.

Optionally, the predicting of the one or more torque actuators of the plurality of torque actuators comprises assigning a value for each torque actuator of the plurality of torque actuators based on the amount of torque available for supply within the predetermined time period for that torque actuator and the predicted torque profile, and the predicted one or more torque actuators of the plurality of torque actuators includes the assigned value for each of the predicted one or more torque actuators. The adjusting of the torque intervention request is then optionally based upon the assigned value of each of the predicted one or more torque actuators of the plurality of torque actuators.

Optionally, the plurality of torque actuators comprises at least one of: an electric motor of the vehicle; an engine ignition of the vehicle; a fast torque delivery actuator of the engine; and a slow torque delivery actuator of the engine.

Optionally, the adjusting of the torque intervention request comprises adjusting one or more of a timing and an amplitude of the torque intervention request based upon the predicted one or more torque actuators for the requested torque intervention.

According to an aspect of the present invention there is provided a vehicle comprising the control system of the previous aspect.

According to an aspect of the present invention there is provided a method for managing the torque of a vehicle, the method comprising: receiving current torque availability data for each of a plurality of torque actuators of a propulsion system of the vehicle, the torque availability data representative of an amount of torque available for supply by the respective torque actuator of the propulsion system of the vehicle within a predetermined time period; receiving a torque intervention request to either increase or decrease the torque supplied by the propulsion system of the vehicle during the predetermined time period; generating a predicted torque profile of the torque intervention request; predicting one or more torque actuators of the plurality of torque actuators for use in a torque intervention during the predetermined time period, the prediction based upon the predicted torque profile and the torque availability data of each of the one or more torque actuators;

This aspect of the present invention may also include the method further comprising: adjusting the torque intervention request based upon the predicted one or more torque actuators of the plurality of torque actuators.

This aspect of the present invention may also include the method further comprising: implementing the adjusted torque intervention request to increase or decrease the torque supplied by the propulsion system of the vehicle during the predetermined time period.

Optionally, the torque availability data for each of the plurality of torque actuators comprises at least one of an upper limit of the torque available that can be supplied by each of the plurality of torque actuators during the predetermined time period, and a lower limit of the torque available that can be supplied by each of the plurality of torque actuators during the predetermined time period.

Optionally, the predicting of the one or more torque actuators of the plurality of torque actuators comprises determining, for each of the one or more torque actuators, that the predicted torque profile is at least one of: less than the upper limit of the torque available during the predetermined time period; and greater than the lower limit of the torque available during the predetermined time period.

Optionally, the predicting of the one or more torque actuators of the plurality of torque actuators comprises determining, for each of the one or more torque actuators, that the predicted torque profile is at least one of:

greater than the upper limit of the torque available during the predetermined time period by less than a predetermined relative amount, or less than the lower limit of the torque available during the predetermined time period by less than a predetermined relative amount.

Optionally, the predicting of the one or more torque actuators of the plurality of torque actuators comprises one of: determining that the predicted torque profile is greater than the upper limit of the torque available during the predetermined time period for a first torque actuator of the plurality of torque actuators; determining that a sum of the upper limit of the torque available during the predetermined time period for the first torque actuator and the upper limit of the torque available during the predetermined time period for a second torque actuator of the plurality of torque actuators of the plurality of torque actuators is greater than the predicted torque profile; and predicting the first and second torque actuators as the predicted one or more torque actuators; or determining that the predicted torque profile is less than the lower limit of the torque available during the predetermined time period for a first torque actuator of the plurality of torque actuators; determining that the sum of the lower limit of the torque available during the predetermined time period for the first torque actuator and the lower limit of the torque available during the predetermined time period for a second torque actuator of the plurality of torque actuators of the plurality of torque actuators is less than the predicted torque profile; and predicting the first and second torque actuators as the predicted one or more torque actuators.

Optionally, the predicting of the one or more torque actuators of the plurality of torque actuators comprises assigning a value for each torque actuator of the plurality of torque actuators based on the amount of torque available for supply within the predetermined time period for that torque actuator and the predicted torque profile; and the predicted one or more torque actuators of the plurality of torque actuators includes the assigned value for each of the predicted one or more torque actuators. The adjusting of the torque intervention request is then optionally based upon the assigned value of each of the predicted one or more torque actuators of the plurality of torque actuators.

Optionally, the plurality of torque actuators comprises at least one of: an electric motor of the vehicle;

an engine ignition of the vehicle; a fast torque delivery actuator of the engine; and a slow torque delivery actuator of the engine.

Optionally, the adjusting of the torque intervention request comprises adjusting one or more of a timing and an amplitude of the torque intervention request based upon the one or more torque actuators for the requested torque intervention.

The same advantages of this method are also present as described above in relation to the preceding aspects. The method may comprise the further restrictions of any of the preceding aspects. For example, the method may further comprise the control system and/or any of the embodiments thereof. Likewise, the method may comprise the vehicle.

According to an aspect of the present invention there is provided computer readable instructions which, when executed by a computer, are arranged to perform a method according to the previous aspect.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIG. 1 shows a vehicle in accordance with embodiments of the invention;

FIG. 2 shows a schematic example of a transmission and a powertrain of a vehicle in accordance with the embodiment of FIG. 1;

FIG. 3 shows a control system in accordance with an embodiment of the invention;

FIG. 4 shows an example plot of a torque intervention according to some embodiments;

FIG. 5 shows a flowchart for determining if an electric machine of a vehicle is predicted as being one of the one or more actuators of a powertrain of the vehicle to supply torque in a torque intervention request according to some embodiments;

FIG. 6 shows a flowchart for determining if an ignition of an engine, or a diesel engine, of a vehicle is predicted as being one of the one or more actuators of a powertrain of the vehicle to supply torque in a torque intervention request according to some embodiments;

FIG. 7 shows a flowchart for determining if a fast (or naturally aspirated) torque or a slow (or turbo-charged) torque of an engine of a vehicle is predicted as being one of the one or more actuators of a powertrain of the vehicle to supply torque in a torque intervention request according to some embodiments;

FIG. 8 shows a flowchart for determining if a combination of actuators is predicted as being the actuators of a powertrain of the vehicle to supply torque in a torque intervention request according to some embodiments; and

FIG. 9 shows a flowchart of the function of a control system according to some embodiments.

### DETAILED DESCRIPTION

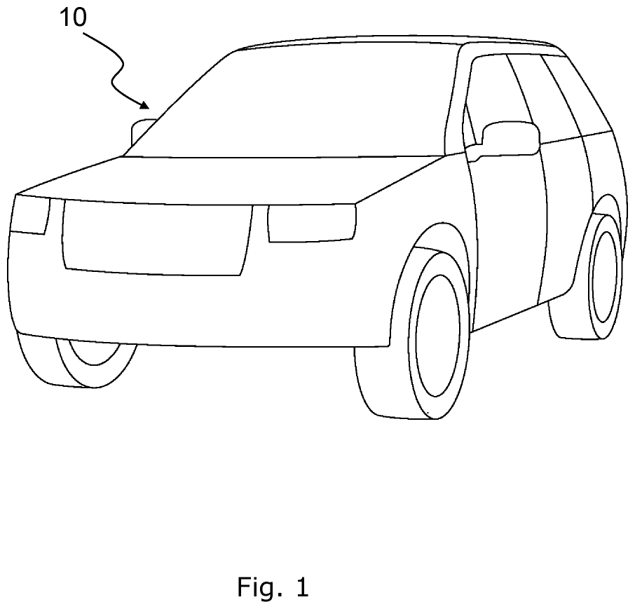

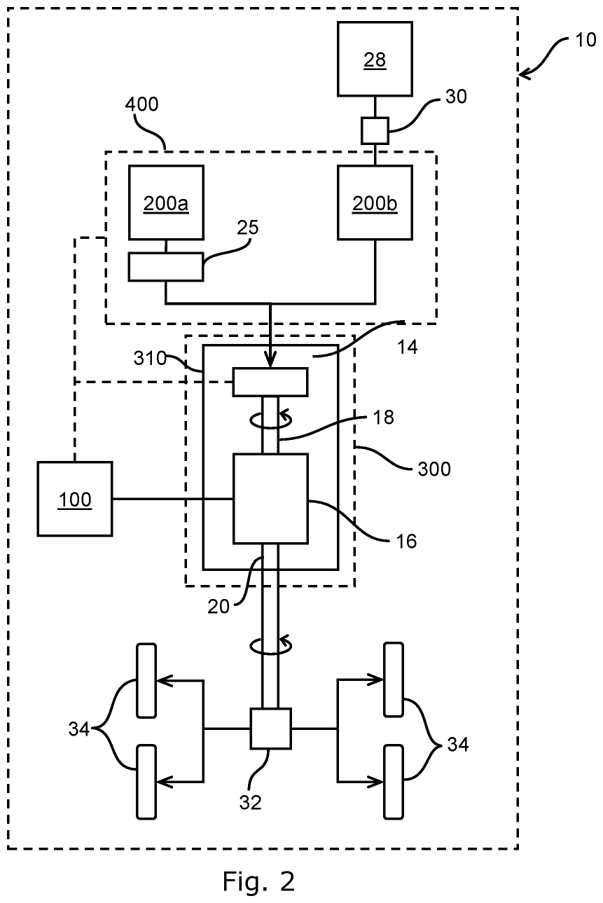

A control system 100 in accordance with an embodiment of the present invention is described herein with reference to the accompanying FIGS. 1 to 9. The control system 100 is suitable for controlling a powertrain of a vehicle 10 with a plurality of actuators 200. As shown in FIG. 2, the control system 100 is installed in a vehicle 10.

The vehicle 10 in accordance with an embodiment of the present invention is described herein with reference to the accompanying FIG. 1. In some, but not necessarily all examples, the vehicle 10 is a passenger vehicle, also referred to as a passenger car or as an automobile. In other examples, embodiments of the invention can be implemented for other applications, such as commercial vehicles.

FIG. 2 schematically includes an illustrated example of at least part of a powertrain 400 of the vehicle 10.

In this example, the vehicle powertrain 400 comprises a plurality of torque actuators 200 (which may also be referred to generically as power sources) which are selectively operable for the purpose of providing drive torque for accelerating or decelerating the vehicle 10. A torque source refers to a prime mover, such as an internal combustion engine 200a, an electric machine 200b such as a traction motor, or the like.

In the illustrated example, the plurality of actuators 200 of the powertrain 400 comprises at least an internal combustion engine 200a (which may include an engine clutch 25) and an electric machine (or electric motor) 200b. In further examples other actuators or torque sources may be present.

The electric machine 200b is an electric motor arranged to convert electrical energy into kinetic energy in the form of mechanical torque and is also arranged to convert kinetic energy in the form of kinetic energy into electrical energy. The electric machine 200b may be an alternating current induction motor or a permanent magnet motor, or another type of suitable known electric machine. The electric machine 200b is a traction motor configured to enable at least an electric mode comprising electric-only driving. That is, the electric machine 200b may, in some scenarios, drive the vehicle 10 by itself (i.e. without an engine). Another term for the electric machine 200b is an electric drive unit (EDU).

The vehicle 10 comprises a transmission system 300 comprising a transmission 310. The transmission 310 comprises an input clutch 14 (also generically known as a coupling element) which transfers torque output by the plurality of torque actuators 200 of the powertrain 400 to the transmission input shaft 18. The input clutch 14 may be a wet clutch such as a torque converter or one or more automatically-actuated friction clutches as found in, for example, a dual-clutch transmission.

The transmission 310 also comprises a gear set and accompanying shifting mechanism, referenced in combination as combined gear-shift mechanism 16. The gear set comprises a plurality of gears which are selectively couplable into different gear trains to enable multiple gear ratios between the transmission input shaft 18 and the transmission output shaft 20.

The clutches and their actuators form the shifting mechanism. The shifting mechanism is controlled to establish a selected gear ratio in accordance with a control signal output by the control system 100, alternatively this may be achieved by a second control system within the vehicle 10 connected or connectable to and in communication with the first control system 100 of the present invention.

The control system 100 is also capable of controlling actuation of the input clutch 14.

The transmission output shaft 20 is connected to a final set of gears 32, such as a pinion gear meshed with a ring gear, to transfer torque to the wheel axles and thus the vehicle wheels 34.

In order to store electrical energy for the electric machine 200b, the vehicle 10 comprises an electrical energy storage means 28. The electrical energy storage means 28 can be a traction battery. The traction battery 28 provides a nominal voltage required by electrical power users such as the electric machine 26.

The traction battery 28 may be a high voltage battery. The traction battery 28 may have a voltage and capacity to support electric only driving for sustained distances. The traction battery 28 may have a capacity of several kilowatt-hours, to maximise range. The capacity may be in the tens of kilowatt-hours, or even over a hundred kilowatt-hours.

Although the traction battery 28 is illustrated as one entity, the function of the traction battery 28 could be implemented using a plurality of small traction batteries in different locations on the vehicle 10 in a manner known in the art.

An inverter 30 converts between the DC output of the traction battery 28 and the AC input required for the electric machine 26.

In view of the above description of the vehicle 10, it will be understood that the vehicle 10 may be a full hybrid electric vehicle (HEV). However, in some examples the vehicle 10 may be other than as shown in FIG. 2. The vehicle 10 may be a battery electric vehicle (BEV), a plug-in electric hybrid vehicle (PHEV), a mild hybrid electric vehicle (MHEV), an internal combustion engine vehicle (ICEV) or otherwise.

MHEVs do not have an electric-only mode of propulsion, but the electric machine 200b may be configured to provide assistance such as boosting output torque of the engine 200a. In such vehicles the electric machine 200b may not be sufficiently powerful to drive the vehicle 10 under electric power alone.

BEVs are an electric-only vehicles which are propelled by an electric machine 200b which receives power from an on-board traction battery 28. ICEV are propelled solely by an engine 200a. In such systems any on-board electric machine is used only as a starter-generator.

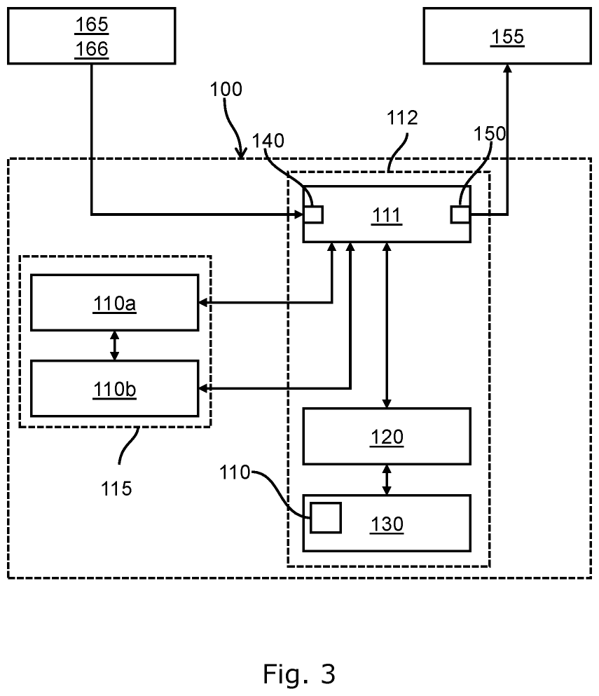

FIG. 3 is an example of the control system 100. The control system comprises one processor 112, although it will be appreciated that this is merely illustrative and that more than one processor 112 may be provided. The processor 112 comprises processing means 120 and memory means 130. The processing means 120 may be one or more electronic processing device 120 which operably executes computer-readable instructions. The memory means 130 may be one or more memory device 130. The memory means 130 is electrically coupled to the processing means 120. The memory means 130 is configured to store instructions, and the processing means 120 is configured to access the memory means 130 and execute the instructions stored thereon.

The processor 112 comprises an input means 140 and an output means 150. The input means 140 may comprise an electrical input 140 of the processor 112. The output means 150 may comprise an electrical output 340 of the processor 112. The processor 112 may have an interface comprising 111 the input means 140 and output means 150. The input means 140 is arranged to receive a torque intervention request signal 165 from a sensor. The torque intervention request signal 165 is an electrical signal which is indicative of a requirement to perform a torque intervention. The input means 140 is also arranged to receive the one or more input parameters 166.

The control system 100 and steps undertaken by the one or more processors 112 to controlling or managing the torque supplied by the powertrain (or propulsion system) 400 of the vehicle 10. The control system 100 may comprise one or more control modules 110 for controlling or managing the torque supplied by the powertrain (or propulsion system) 400 of the vehicle 10.

The control system 100 may comprise one or more modules 110. The one or more modules 110 of the control system 100 may include a powertrain control module 110a and a transmission control module 110b. In some embodiments, the same function of the powertrain control module 110a and the transmission control module 110b may be carried out by other modules or systems of the vehicle. As such, the powertrain control module 110a and the transmission control module 110b may be respectively referred to as a first control module 110a and a second control module 110b. Alternatively or in addition, in some embodiments the powertrain control module 110a and the transmission control module 110b may be implemented separately or may be implemented are part of a single module. In some embodiments, one or more controllers 115 of the control system 100 may comprise the one or more control modules 110.

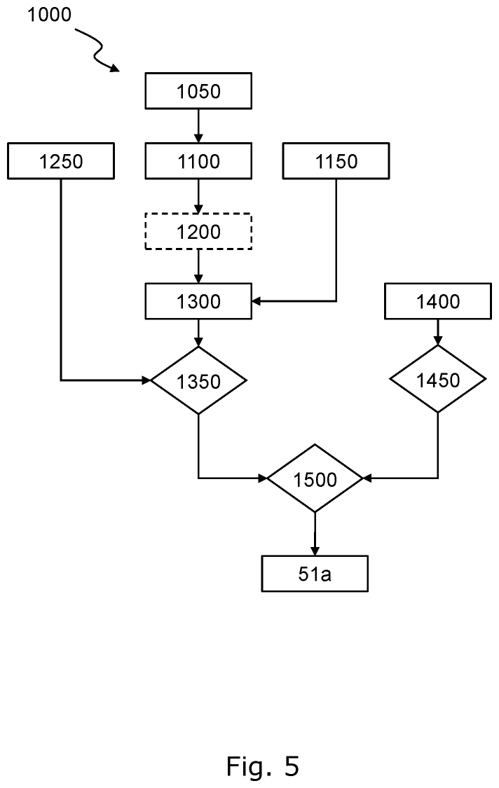

The manner in which the control system 100 controls or manages the torque supplied by the powertrain (or propulsion system) 400 of the vehicle 10 will be discussed in more detail with the aid of FIGS. 5 to 9.

The vehicle 10 includes a plurality of torque actuators 200, each torque actuator being a component or element of the powertrain 400 of the vehicle 10 that is able to deliver torque to the transmission 300 of the vehicle 10. The plurality of torque actuators 200 may include one or more of: an internal combustion engine 200a; an electric engine (or electric motor) 200b; an engine clutch 200c; or a launch device 200d such as a clutch or torque converter.

Whilst the control system 100 as illustrated in FIG. 3 comprises several specific control modules 110, it will be appreciated that the various components and control modules shown in FIG. 3 are merely illustrative, and may be added to, or omitted, depending on the specific vehicle 10 in question. For example, if the vehicle 10 is not an electric or hybrid vehicle, then the electric engine 200b may be omitted, or if the vehicle is a wholly electric vehicle 10, the internal combustion engine 200a may be omitted. Similarly, other or additional components or control modules may be included depending on the specific vehicle 10 in question.

In addition, and as discussed above, the control modules 110 of the control system 100 may be implemented as part of one or more controllers 115, or as separate control modules of the control system 100.

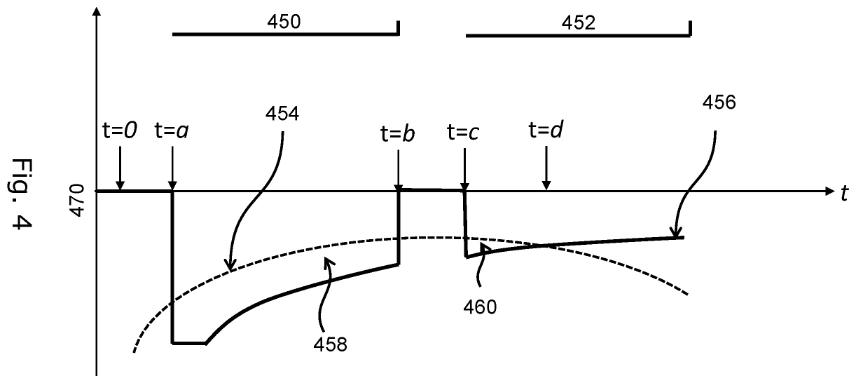

FIG. 4 shows an example plot of a conventional torque intervention, showing the relative minimum amount of torque that can be supplied by the powertrain 400 over a period of time, as well as a requested decrease in torque over that time period according to a torque intervention request that represents two successive upshifts in gears.

The graph of FIG. 4 can be labelled as follows:

| | |
|---|---|
| 450 | First Gear Upshift |
| 452 | Second Gear Upshift |
| 454 | Relative Powertrain Lower Limit |
| 456 | Relative Torque Intervention Request |
| 458 | First Region of Torque Supply Shortfall |
| 460 | Second Region of Torque Supply Shortfall |
| 470 | Torque supplied by the Powertrain |

During a torque intervention, the torque supplied by the powertrain 400 is increased or decreased to meet a given demand, for instance during a gear shift in the vehicle 10. For example, during a gear shift of the vehicle 10, the transmission 300 sends a request for torque intervention to compensate for the input speed inertia change, to avoid a disturbance from the positive slip created in the transmission. The powertrain 400 then supplies that requested increase in torque.

Whilst the precise form of the gear shift, or indeed a torque intervention in general, may vary depending on the specific circumstances of the torque intervention request, the example plot of FIG. 4 is used to describe the general principles of a torque intervention.

The system torque capability (e.g. the torque that can be delivered by the internal combustion engine, hybrid vehicle battery, inverter, etc.), or the available torque, are likely to vary based on the current system or driving conditions. As a result, when a torque intervention is implemented, there may be insufficient torque available to completely fulfil the torque intervention.

This is shown in FIG. 4 where, during the two successive gear upshifts, there is insufficient torque available to meet the requirements of the torque intervention. At t=0, no torque intervention is taking place and the powertrain 400 is providing a consistent amount of torque to drive the vehicle 10 (since the example plot of FIG. 4 is relative, this is set to zero). At t=a, an upshift in the gears takes place, and a request for torque intervention is received by the powertrain 400 (shown as a solid line in FIG. 4). The size of the increase or decrease in the torque supplied by the powertrain 400 during the request for torque intervention varies over the period the intervention is taking place, and is determined based on the specific circumstances at that time (i.e. each request for torque intervention will have its own specific profile that is dependent on the current circumstances).

However, between t=a and t=b, the size of the requested decrease in the amount of torque supplied by the powertrain 400 is greater than the lower limit of torque that the powertrain can deliver at that time. As a result, between t=a and t=b, the powertrain 400 can only deliver a decrease in torque that is within its current lower limit (shown as a dotted line in FIG. 4), creating a region of torque supply shortfall. Here, it is highlighted that the amount of any increase or a decrease in the torque that can be supplied by the powertrain 400 varies with time based on the current state of the actuators of the powertrain 400, and therefore the lower limit (i.e. The dotted line of FIG. 4) likewise varies with time. This shortfall in the torque that can be supplied by the powertrain 400 compared with the request for torque intervention then negatively affects the quality of the gear shift.

At t=b, the first gear upshift is completed, and the relative torque returns to its previous value (again, this since the example plot of FIG. 4 is relative, this is set to zero).

At t=c, a second upshift in the gears takes place, and a further request for torque intervention is received by the powertrain 400. However, as before, between t=c and t=d, the size of the requested decrease in the amount of torque supplied by the powertrain 400 is greater than the lower limit of torque that the powertrain can deliver at that time. As a result, between t=c and t=d, the powertrain 400 can only deliver a decrease in torque up to its current lower limit (shown as a dotted line in FIG. 4), creating a second region of torque supply shortfall. However, since the size of the requested decrease in torque is less than in the first gear upshift, this second region of torque supply shortfall is shorter and shallower, and may have less of a negative impact on the quality of the gear upshift compared with the first region of torque supply shortfall. In some circumstances, such a short and shallow region of torque supply shortfall may therefore be acceptable, or may nonetheless still result in a degraded gear shift quality.

After t=d the powertrain is able to supply the requested decrease (i.e. because the size of the requested decrease after t=d is within the lower limit of the torque available for supply by the powertrain 400 at that time).

Such a scenario (where the powertrain is currently unable to meet the requested change in torque) may arise for a number of reasons. As a non-limiting example, the high voltage battery of the vehicle may be full, such that the minimum torque capability is reduced or restricted since the battery cannot be charged any further (or further charging would be inadequate). As a further non-limiting example, the high voltage battery of the vehicle may be very cold, leading to reduced power availability. As a further non-limiting example, the current temperature of the engine of the vehicle may have an effect on the internal friction and minimum value of fuel-cut torque (i.e. when no fuel is currently being injected into the engine). As a further non-limiting example, the engine of the vehicle may or may not be on boost via its turbocharger, affecting how much instant torque can be delivered.

This results in the powertrain under delivering, or completely ignoring, transmission interventions, and alters the driveability of the vehicle (due to shift control and quality), resulting in gear shift quality degradation and possibly interventions that are missed entirely.

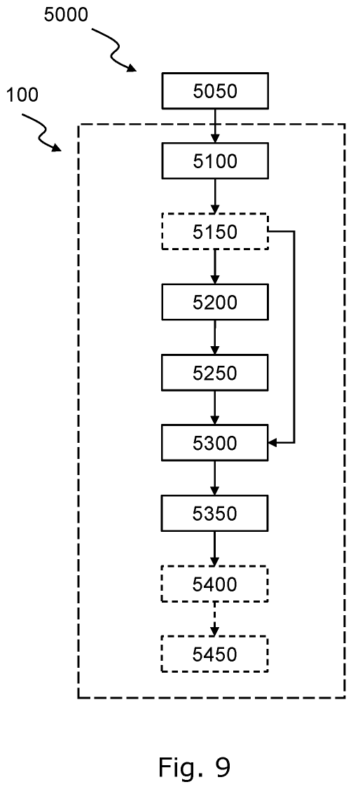

The control system 100 of the present invention is configured to manage the torque supplied by the powertrain 400 of the vehicle 10 during a torque intervention request by predicting one or more actuators of the powertrain 400 that will supply the torque (as discussed with reference to FIGS. 5 to 8). The torque intervention request can then be adjusted in view of the current torque that can be supplied by the predicted one or more actuators (as discussed with reference to FIG. 9), such that the torque intervention does not experience a shortfall of torque (or experiences only an acceptable level of shortfall of torque) supplied from the powertrain 400.

This therefore allows the transmission to better control each gear shift, since the transmission is aware of what torque can be delivered by the powertrain 400, rather than the transmission requesting an amount of torque that cannot currently be fulfilled by the powertrain 400 (thereby affecting the quality of the gear shift).

In more detail, the powertrain control module 110a of the control system 100 is configured to receive torque availability data 500 from each of the plurality of torque actuators 200. The torque availability data 500 comprises the current amount of torque available for supply by the associated torque actuator of the powertrain 400 of the vehicle 10.

In some embodiments, the torque availability data 500 may be collected for each actuator of the plurality of actuators 200 in real time (i.e. outside of a period of gear shifting). Here, each torque actuator of the plurality of torque actuators 200 may collect torque availability data 500 continuously, for instance every time a certain predetermined period of time has elapsed. For example, each of the plurality of torque actuators 200 may collect torque availability data 500 every 200 milliseconds. In another example, each of the plurality of torque actuators 200 may collect torque availability data 500 every 2 seconds. Here, it will be understood that the predetermined period of time in which the torque availability data 500 is collected may be chosen to be any suitable length of time.

The control system 100 then provides the torque availability data 500 to the powertrain control module 110a.

When the amount of torque supplied by the powertrain 400 of the vehicle 10 must be changed (for instance during a gear shift), a torque intervention request may be generated. The torque intervention request relates to a request to increase or decrease the current amount of torque supplied by the powertrain 400 of the vehicle 10, for example during a gear shift (as discussed above with reference to the example plot of FIG. 4).

The torque intervention request may be generated by a further module of the control system 100, or may be generated by another system of the vehicle and provided to the control system 100. In some embodiments, the transmission control module 110b of the control system 100 may generate the torque intervention request based upon receiving a signal to do so, or may receive the torque intervention request from another module of the control system 100 or another system of the vehicle 10 entirely.

The powertrain control module 110a may then receive the torque intervention request from the transmission control module 110b of the control system 100.

The powertrain control module 110a may then generate a predicted torque profile of the received torque intervention request. That is to say, the powertrain control module 110a may generate a predicted profile of the change in torque supplied by the powertrain 400 based on the received torque intervention request. The predicted profile may have a predicted timing and amplitude for the change in torque during the torque intervention request.

In some embodiments, the received torque intervention request may be a predicted torque intervention request. That is to say, the received torque intervention request may not be a “real” torque intervention request, and may instead be a predicted torque intervention request generated to ideally match a real torque intervention request received (or generated in response to receiving a signal indicating a torque intervention, such as a gear shift) at a later time. For example, the control system 100 may predict the next torque intervention and generate a predicted torque intervention request that matches that predicted next torque intervention. For example, a predicted torque intervention request can be generated as the “received” torque intervention request based on historical data from previous torque interventions. The predicted torque intervention request may be for a specific torque intervention (e.g. a specific gear shift up or gear shift down) and therefore may be generated based on historical data of a torque intervention that matches that specific torque intervention. In other words, to determine a predicted torque intervention request for a particular gear shift up, the historical data associated with such a particular gear shift is used. In other examples other predetermined predicted torque intervention requests may be used, for example a library or database of predetermined predicted torque intervention requests used. It will be understood that this may apply to any embodiment discussed below with respect to FIGS. 5 to 9.

In some embodiments, the transmission control module 110b may generate the predicted profile of the change in torque supplied by the powertrain 400 based on the receive torque intervention request, and supply the predicted profile to the powertrain control module 110a instead of, or in addition to, the torque intervention request. In such scenarios, the powertrain control module 110a then predicts the one or more torque actuators based on the received predicted profile of the change in torque received from the transmission control module 110b. Again, it will be understood that this may apply to any embodiment discussed below with respect to FIGS. 5 to 9.

The powertrain control module 110a may then use the generated predicted torque profile and the received torque availability data 500 for the predetermined time period to predict one or more torque actuators of the plurality of torque actuators 200 to be used in the torque intervention during the predetermined time period to deliver the requested change in torque.

Once the powertrain control module 110a has predicted the one or more torque actuators of the plurality of torque actuators 200 to be used in the torque intervention during the predetermined time period to deliver the requested change in torque, the powertrain control module 110a may output the predicted the one or more torque actuators to the transmission control module 110b.

The transmission control module 110b may then adjust the received torque intervention request based on the predicted the one or more torque actuators, and implement the adjusted torque intervention request using the predicted one or more torque actuators.

In some embodiments, the transmission control module 110b may adjust the timing and the amplitude of the received torque intervention request in view of the predicted one or more torque actuators.

For example, if the predicted one or more torque actuators is/are able to supply the requested increase or decrease in torque, but is unable to supply that increase or decrease in torque fast enough to meet the torque intervention request, the transmission control module 110b may adjust the timing of the torque intervention request such that the predicted one or more torque actuators is/are able to supply that requested change in torque in the required timeframe.

As a further example, if the predicted one or more torque actuators is/are able to supply the requested increase or decrease in torque sufficiently quickly, but is unable to supply all of the requested increase or decrease in torque to meet the torque intervention request, the transmission control module 110b may adjust the amplitude of the torque intervention request such that the predicted one or more torque actuators is/are able to supply that requested change in torque.

In some embodiments, the transmission control module 110b may then implement the adjusted torque intervention request to increase or decrease the torque supplied by the propulsion system 400 of the vehicle 10. The implemented adjusted torque intervention request may include using the predicted one or more actuators received from the powertrain control module 110a to supply the requested change in torque.

This therefore allows the transmission to better control each given torque intervention (e.g. each gear shift), since the transmission is aware of what torque can be delivered by the most appropriate actuator(s) of the powertrain 400, rather than the transmission requesting an amount of torque that cannot currently be fulfilled by the powertrain 400 (thereby affecting the quality of the gear shift). As such, the torque intervention request can be adjusted and implemented to best suit the most appropriate actuators of the powertrain 400 (i.e. the predicted one or more actuators). This then improves the control and quality of the gear shift, and improves the overall drivability of the vehicle 10.

In some embodiments, the powertrain control module 110a may use the torque availability data 500 to calculate an upper limit 550a (or a maximum, or an upper threshold) of the torque currently available for torque intervention during the predetermined time period for each of the torque actuators based on the torque availability data 500. For example, the powertrain control module 110a may calculate that the upper limit 550a of currently available torque that can be supplied by each torque actuator of the plurality of torque actuators 200 of the powertrain 400 in the current predetermined time period is 800 Nm

In some embodiments, the powertrain control module 110a may use the torque availability data 500 to calculate a lower limit (or a minimum, or a lower threshold) 550b of the torque available for torque intervention during the predetermined time period for each of the torque actuators based on the torque availability data 500. For example, the powertrain control module 110a may calculate that the lower limit 550b of currently available torque that can be supplied by each of the plurality of torque actuators 200 of the powertrain 400 in the current predetermined time period is 50 Nm.

Therefore, the calculated upper limit 550a, or maximum currently available torque for each torque actuator, reflects the maximum torque that can be supplied by each of the plurality of torque actuators 200 of the powertrain 400 during that current predetermined time period. Similarly, the calculated lower limit 550b, or minimum currently available torque for each torque actuator, reflects the minimum torque that can be supplied by each of the plurality of torque actuators 200 of the powertrain 400 during that current predetermined time period.

In some embodiments, one or both of the upper limit 550a and the lower limit 550b for each torque actuator may be calculated for every time period, regardless of whether a torque intervention request is received. Alternatively, in some embodiments, one or both of the upper limit 550a and the lower limit 550b for each torque actuator may be calculated only when a torque intervention request is received.

In some embodiments, the calculated one or both of the upper limit 550a and the lower limit 550b for each torque actuator of the plurality of torque actuators 200 may be used to predict the one or more torque actuators of the plurality of torque actuators 200 to be used in the torque intervention during the predetermined time period to deliver the requested change in torque. In some embodiments, the powertrain control module 110a may determine, for each torque actuator, whether the predicted torque profile is less than the upper limit 550a of the torque available during the predetermined time period for that torque actuator or greater than the lower limit 550b of the torque available during the predetermined time period for that torque actuator. The powertrain control module 110a may then predict the one or more torque actuators based on that determination.

In some embodiments, the powertrain control module 110a may determine, for each torque actuator, whether the predicted torque profile is greater than the upper limit 550a of the torque available for that torque actuator by less than a predetermined amount. For example, the powertrain control module 110a may determine for each torque actuator whether the highest value of the predicted torque profile exceeds the upper limit 550a of the torque available for that actuator by less than 50 Nm. If the powertrain control module 110a determines that this is the case for that torque actuator, the powertrain control module 110a may predict that that actuator is used in the torque intervention being implemented during the current predetermined time period.

Similarly, in some embodiments, the powertrain control module 110a may determine, for each torque actuator, whether the predicted torque profile is less than the lower limit 550b of the torque available for that torque actuator by less than a predetermined amount. For example, the powertrain control module 110a may determine for each torque actuator whether the lowest value of the predicted torque profile exceeds the lower limit 550b of the torque available for that actuator by less than 50 Nm. If the powertrain control module 110a determines that this is the case for that torque actuator, the powertrain control module 110a may predict that that actuator is used in the torque intervention being implemented during the current predetermined time period.

In some embodiments, the predetermined amount may be calculated as a percentage of the received torque intervention request. For example, the powertrain control module 110a may determine for each torque actuator whether the highest value of the predicted torque profile exceeds the upper limit 550a of the torque available for that actuator by less than 10% of the torque intervention request. If the powertrain control module 110a determines that this is the case for that torque actuator, the powertrain control module 110a may predict that that actuator is used in the torque intervention being implemented during the current predetermined time period. As a further example, the powertrain control module 110a may determine for each torque actuator whether the lowest value of the predicted torque profile exceeds the lower limit 550b of the torque available for that actuator by less than 10% of the torque intervention request. If the powertrain control module 110a determines that this is the case for that torque actuator, the powertrain control module 110a may predict that that actuator is used in the torque intervention being implemented during the current predetermined time period. Here, it will be understood that any suitable percentage value may be chosen.

In some embodiments, the powertrain control module 110a may predict the one or more torque actuators of the plurality of torque actuators 200 by assigning a value or parameter for each torque actuator of the plurality of torque actuators 200 based on the amount of torque available for supply by that torque actuator and the predicted torque profile. The output to the transmission control module 100b of the one or more predicted torque actuators may then include the assigned value (or parameter) for each of the predicted one or more torque actuators.

In some embodiments, the assigned value for each of the torque actuators of the plurality of torque actuators 200 may be a Boolean flag, indicating that that torque actuator has been predicted as one of the one or more torque actuators that may fulfil the received toque intervention request.

In some embodiments, the powertrain control module 110a of the control system 100 may assign a primary actuator of the plurality of actuators 200, and a secondary actuator of the plurality of actuators 200. For example, the powertrain control module 110a may assign the internal combustion engine 200a as the primary actuator, and the electric machine 200b as the secondary actuator. The assigned actuator for each of the primary and secondary actuators may be predetermined, or may be periodically reassigned as required by current circumstances or requirements.

In some embodiments, the powertrain control module 110a of the control system 100 may use the generated predicted profile for a received torque intervention request to express at least one of the upper limit 550a and the lower limit 550b for each actuator as a percentage value associated with the received torque intervention request.

Here, and as discussed above, the powertrain control module 110a may receive a torque intervention request and generate a predicted profile of the change in torque supplied by the powertrain 400 based on the received torque intervention request.

As discussed above, in some embodiments, the transmission control module 110b may alternatively receive the torque intervention request, or generate the torque intervention request (for example, in response to receiving a signal indicating a gear shift).

In some embodiments, the received (or generated, in response to receiving a signal indicating a torque intervention, such as a gear shift) torque intervention request may be a predicted torque intervention request. Again, it will be understood that this may apply to any embodiment discussed below with respect to FIGS. 5 to 9.

Then, the powertrain control module 110a may recalculate the at least one of the upper limit 550a and the lower limit 550b for each actuator as a percentage of the peak (i.e. the highest or lowest point) of the predicted profile for that received torque intervention request.

For example, the upper limit 550a for the engine 200a actuator may be calculated to be +100 Nm, and the peak of the predicted profile for a received torque intervention request may be calculated to be +115 Nm. As such, the upper limit 550a of torque available for supply by the engine 200a is 115% of the predicted torque needed for that torque intervention request.

As a further example, the lower limit 550b for the electric machine 200b actuator may be calculated to be −80 Nm, and the peak of the predicted profile for a received torque intervention request may be calculated to be −90 Nm. As such, the lower limit 550b of torque available for supply by the electric machine 200b is 88.8% of the predicted torque needed for that torque intervention request.

In some embodiments, the at least one of the upper limit 550a and the lower limit 550b for each of the assigned primary and secondary actuators may then be respectively recalculated as a percentage of the peak in requested torque of a received torque intervention request.

The discussion below, with reference to FIGS. 5 to 8, concerns examples of how the powertrain control module 110a may predict which one or more actuators of the plurality of actuators 200 may deliver the change in torque requested in a request for torque intervention. One or more of the methods of FIGS. 5 to 8 may be carried out by the powertrain control module 110a concurrently or successively, depending on specific requirements and circumstances.

It will be understood that the specific methods described with reference to FIGS. 5 to 8 are merely examples, and that certain steps may be altered or replaced with other steps as appropriate in specific circumstances and for specific vehicles (e.g. where the vehicle 10 is a battery electric vehicle (BEV), or is a fully internal combustion engine vehicle (ICEV)).

FIG. 5 shows a method 1000 by which the powertrain control module 110a determines whether the electric machine (or electric motor) 200b (where the vehicle 10 comprises an electric motor) should be predicted as one of the one or more torque actuators for supplying the torque requested in a torque intervention request.

At step 1050, the torque availability data 500 is collected for each actuator of the plurality of actuators 200. As discussed above, each torque actuator of the plurality of torque actuators 200 may collect torque availability data 500 continuously (i.e. in real time), for instance every time a certain predetermined period of time has elapsed.

The torque availability data 500 received by the powertrain control module 110a may include the currently available torque that can be delivered by the electric machine (or electric motor) 200b.

At step 1100, at least one of the upper limit 550a and the lower limit 550b for the electric machine (or electric motor) 200b is calculated based on the maximum currently available torque that can be delivered by the electric machine (or electric motor) 200b.

At step 1150, the powertrain control module 110a receives a torque intervention request and generates a predicted profile of the change in torque supplied by the powertrain 400 based on the received torque intervention request. This may, for example, correspond with time t=a, or just prior to time t=a in FIG. 4.

At step 1200, the powertrain control module 110a may optionally recalculate the at least one of the upper limit 550a and the lower limit 550b of each actuator as a percentage of the predicted peak of the profile generated based on the received torque intervention request.

At step 1250, the powertrain control module 110a determines whether the electric machine 200b is currently assigned as the primary actuator.

At step 1300, the powertrain control module 110a determines whether the upper limit 550a or lower limit 550b of the electric machine 200b exceeds the predicted peak of the torque intervention request profile.

In some embodiments, the powertrain control module 110a may instead determine whether the upper limit 550a or lower limit 550b of the electric machine 200b can provide at least a threshold percentage of the predicted peak of the torque intervention request profile. For example, the powertrain control module 110a may determine whether the upper limit 550a of the electric machine 200b is within 80% of the predicted peak of the torque intervention request profile.

In some embodiments, the threshold percentage may be a threshold for combined intervention, where multiple actuators of the plurality of actuators 200 are predicted to supply the torque requested in the torque intervention request. For example, the threshold for combined intervention may be set to 80% of the peak of the predicted profile of request torque, and if the electric machine 200b is only able to supply 70% of that requested torque, then multiple actuators may be predicted to supply that requested torque (as discussed further below).

At step 1350, the powertrain control module 110a determines whether the determinations of both step 1250 and step 1300 are “true”. That is to say, the powertrain control module 110a determines whether the electric machine 200b is the primary actuator and whether the upper limit 550a or lower limit 550b of the electric machine 200b exceeds (or is above a predetermined threshold percentage of) the predicted peak of the torque intervention request profile.

At step 1400, the powertrain control module 110a determines whether the lower limit 550b of the electric machine 200b is less than a low contribution threshold percentage of the predicted peak of the torque intervention request profile. For example, the low contribution threshold percentage may be set to be 20% of the peak of the predicted profile of request torque, and the lower limit 550b of the electric machine 200b may only be able to supply 15% of the peak of the predicted profile of request torque.

At step 1450, the powertrain control module 110a determines whether the determination of step 1400 is “true”, and whether the engine 200a is the primary actuator but is only capable of providing a small proportion of the requested torque (i.e. below the low contribution threshold percentage). That is to say, the powertrain control module 110a determines that the contribution of the engine 200a would be nearly negligeable, despite being the primary actuator.

At step 1500, the powertrain control module 110a determines whether either the output from step 1350 or the output of step 1450 is “true”. If the output of either step is determined to be “true”, then the powertrain control module 110a predicts the electric machine 200b as the actuator that will deliver the torque requested in the torque intervention request.

The powertrain control module 110a may then output to the transmission control module 110b the electric machine 200b as being one of the predicted one or more torque actuators of the plurality of torque actuators 200 to be used in the torque intervention.

In some embodiments, this may take the form of setting a Boolean flag for the electric machine 200b, and providing the transmission control module 110b with that Boolean flag to identify the electric machine 200b as being the predicted torque actuator of the plurality of torque actuators 200 to be used in the torque intervention. Here, in such embodiments, it is noted that only one Boolean flag may be set at any one time.

If the output of both step 1350 and step 1450 is determined to be “false”, then the powertrain control module 110a does not predict the electric machine 200b as the actuator that will deliver the torque requested in the torque intervention request.

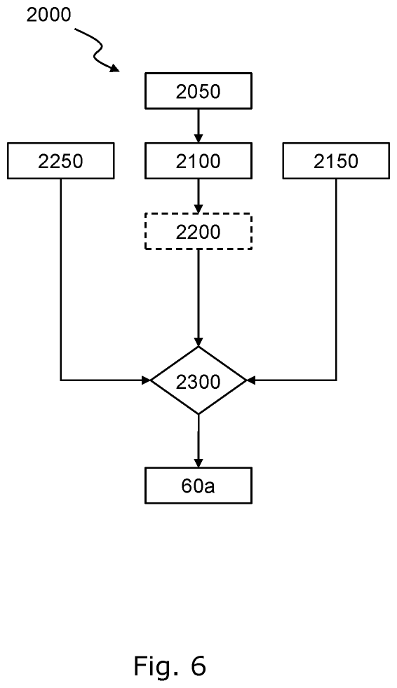

FIG. 6 shows a method 2000 by which the powertrain control module 110a determines whether the engine ignition of the engine 200a or, in the case of a diesel engine, the diesel engine 200a of the vehicle 10 should be predicted as one of the one or more torque actuators for supplying a decrease in torque requested in a torque intervention request.

At step 2050, the torque availability data 500 is collected for each actuator of the plurality of actuators 200. As discussed above, each torque actuator of the plurality of torque actuators 200 may collect torque availability data 500 continuously (i.e. in real time), for instance every time a certain predetermined period of time has elapsed.

The torque availability data 500 received by the powertrain control module 110a may include the currently available torque that can be delivered by the engine ignition of the engine 200a (or, in the case of a diesel engine, the diesel engine 200a).

At step 2100, at least one of the upper limit 550a and the lower limit 550b for the engine ignition of the engine 200a (or, in the case of a diesel engine, the diesel engine 200a) is calculated based on the currently available torque that can be delivered by the engine ignition of the engine 200a (or, in the case of a diesel engine, the diesel engine 200a).

At step 2150, the powertrain control module 110a receives a torque intervention request and generates a predicted profile of the change in torque supplied by the powertrain 400 based on the received torque intervention request. This may, for example, correspond with time t=a, or just prior to time t=a in FIG. 4.

As discussed above, in some embodiments, the received torque intervention request may be a predicted torque intervention request, which is generated (e.g. by the transmission control module 110b) to ideally match a torque intervention request received (or generated, in response to receiving a signal indicating a torque intervention, such as a gear shift) at a later time.

At step 2200, the powertrain control module 110a may optionally recalculate each of the at least one of the upper limit 550a and the lower limit 550b of each actuator as a percentage of the predicted peak of the profile generated based on the received torque intervention request.

At step 2250, the powertrain control module 110a determines whether the lower limit 550b of the engine ignition of the engine 200a (where the lower limit 550b was calculated in step 2100) or, in the case of a diesel engine, the diesel engine 200a is less than a low contribution threshold percentage of the predicted peak of the torque intervention request profile. For example, the low contribution threshold percentage may be set to be 20% of the peak of the predicted profile of request torque, and the lower limit 550b of the engine ignition of the engine 200a or, in the case of a diesel engine, the diesel engine 200a, may only be able to supply 15% of the peak of the predicted profile of request torque.

If the output of step 2250 is determined to be “true” then, at step 2300, the powertrain control module 110a carries out an arbitration to assess whether the engine ignition of the engine 200a or, in the case of a diesel engine, the diesel engine 200a should be predicted as one of the one or more actuators that will deliver the torque requested in the torque intervention request.

This arbitration is a series of checks and calculations to confirm the engine ignition of the engine 200a will be able to supply sufficient torque to meet the peak of the torque intervention request profile. It will be understood that the specific series of checks and calculations may vary from scenario to scenario

The arbitration at step 2300 comprises comparing following parameters:
The lower limit 550b of engine ignition torque (or, in the case of a diesel engine, the diesel engine 200a).
The current engine 200a speed.
The torque currently being supplied by the engine 200a (i.e. without torque intervention).
Whether the engine 200a (or, in the case of a diesel engine, the diesel engine 200a) is currently assigned as the primary actuator.
The peak torque of the predicted torque intervention profile.
Whether the lower limit 550b of the engine ignition of the engine 200a (or, in the case of a diesel engine, the diesel engine 200a) exceeds a predetermined threshold percentage of the peak of the predicted torque intervention profile for ignition (or diesel) torque actuation. (For example, if the predetermined threshold percentage of the peak of the predicted torque intervention profile is 80%, and if the lower limit 550b of the engine ignition of the engine 200a (or, in the case of a diesel engine, the diesel engine 200a) is greater than 80% of the peak of the predicted torque intervention profile).

If, in view of these parameters, the powertrain control module 110a determines in the arbitration of step 2300 that the engine ignition of the engine 200a (or, in the case of a diesel engine, the diesel engine 200a) can deliver the requested torque for the predicted torque intervention profile, then the powertrain control module 110a predicts the engine ignition of the engine 200a (or, in the case of a diesel engine, the diesel engine 200a) as the actuator that will deliver the torque requested in the torque intervention request.

For example, the powertrain control module 110a may determine that the engine ignition of the engine 200a (or, in the case of a diesel engine, the diesel engine 200a) is currently assigned as the primary actuator. The powertrain control module may also determine, based on the current engine speed, the torque currently being supplied by the engine 200a, the lower limit 550b for that actuator, the peak in the predicted torque profile, and whether the lower limit 550b exceeds the predetermined threshold percentage of the peak of the predicted torque intervention profile, that the engine ignition of the engine 200a (or, in the case of a diesel engine, the diesel engine 200a) is able to supply the requested decrease in torque for the torque intervention request.

The powertrain control module 110a may then output to the transmission control module 110b the engine ignition of the engine 200a (or, in the case of a diesel engine, the diesel engine 200a) as being one of the predicted one or more torque actuators of the plurality of torque actuators 200 to be used in the torque intervention for decreasing the torque supplied by the powertrain 400.

In some embodiments, this may take the form of setting a flag, such as a Boolean flag, for the engine ignition of the engine 200a (or, in the case of a diesel engine, the diesel engine 200a), and providing the transmission control module 110b with that Boolean flag to identify the engine ignition of the engine 200a (or, in the case of a diesel engine, the diesel engine 200a) as being the predicted torque actuator of the plurality of torque actuators 200 to be used in the torque intervention for decreasing the torque supplied by the powertrain 400. Here, in such embodiments, it is noted that only one Boolean flag may be set at any one time.

If it is determined in step 2300 that the engine ignition of the engine 200a (or, in the case of a diesel engine, the diesel engine 200a) cannot supply the requested torque for the torque intervention request, then the powertrain control module 110a does not predict the engine ignition of the engine 200a (or, in the case of a diesel engine, the diesel engine 200a) as the actuator that will deliver the decrease in torque requested in the torque intervention request.

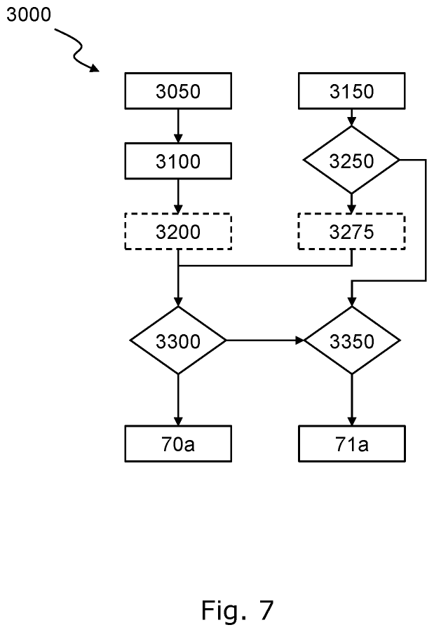

FIG. 7 shows a method 3000 according to some embodiments in which the powertrain control module 110a determines whether a “fast torque” the engine 200a of the vehicle 10 or a “slow torque” of the engine 200a of the vehicle 10 should be predicted as one of the one or more torque actuators for supplying the torque requested in a torque intervention request.

At step 3050, the torque availability data 500 is collected for each actuator of the plurality of actuators 200. As discussed above, each torque actuator of the plurality of torque actuators 200 may collect torque availability data 500 continuously (i.e. in real time), for instance every time a certain predetermined period of time has elapsed.

Here, the torque availability data 500 may include the currently available torque that can be supplied by the engine 200a “fast torque” (e.g. a quickly attainable naturally aspirated torque from the engine), and the engine 200a “slow torque” (e.g. a more slowly attainable turbo-charged torque from the engine, where the engine has a turbo).

At step 3100, at least one of the upper limit 550a and the lower limit 550b for the fast torque and slow torque actuators are calculated based on the torque currently available from the engine “fast torque” and the torque currently available from the engine “slow torque”.

At step 3150, the powertrain control module 110a receives a torque intervention request and generates a predicted profile of the change in torque supplied by the powertrain 400 based on the received torque intervention request. This may, for example, correspond with time t=a, or just prior to time t=a in FIG. 4.

As discussed above, in some embodiments, the received torque intervention request may be a predicted torque intervention request. That is to say, the received torque intervention request may not be a “real” torque intervention request, and may instead be a predicted torque intervention request generated to ideally match a real torque intervention request received (or generated in response to receiving a signal indicating a torque intervention, such as a gear shift) at a later time. For example, the next torque intervention may be predicted and a predicted torque intervention request may be generated (e.g. by the powertrain control module 110a or the transmission control module 110b) that matches that predicted next torque intervention.

For example, a predicted torque intervention request can be generated as the “received” torque intervention request based on historical data from previous torque interventions. The predicted torque intervention request may be for a specific torque intervention (e.g. a specific gear shift up or gear shift down) and therefore may be generated based on historical data of a torque intervention that matches that specific torque intervention. In other words, to determine a predicted torque intervention request for a particular gear shift up, the historical data associated with such a particular gear shift is used. In other examples other predetermined predicted torque intervention requests may be used, for example a library or database of predetermined predicted torque intervention requests used.

At step 3200, the powertrain control module 110a may optionally recalculate the at least one of the upper limit 550a and the lower limit 550b of each of the fast torque and slow torque of the engine 200a as a percentage of the predicted peak of the profile generated based on the received torque intervention request.

At step 3250, the powertrain control module 110a determines whether the peak amount of torque of the predicted torque profile is greater than zero (i.e. an increase in torque is requested in the torque intervention request).

In some embodiments, in step 3275 the powertrain control module 110a may optionally carry out a calibration to characterise the currently available engine torque. Here, the torque availability data 500 may include current ambient pressure and the current engine speed, which the powertrain control module 110a may use to carry out this optional calibration.

In step 3300, the powertrain control module 110a carries out an arbitration to assess whether the engine 200a fast torque should be predicted as one of the one or more actuators that will deliver the torque requested in the torque intervention request.

This arbitration is a series of checks and calculations to confirm the engine 200a fast torque will be able to supply sufficient torque to meet the peak of the torque intervention request profile. It will be understood that the specific series of checks and calculations may vary from scenario to scenario.

The arbitration at step 3300 comprises comparing following parameters:
The current ambient pressure and current engine speed (which may be calibrated as discussed above with respect to step 3275).
Whether the peak amount of torque of the predicted torque profile is greater than zero (as determined from step 3250).
The peak torque in the predicted torque intervention profile.
Whether the engine 200a is currently assigned as the primary actuator.
The torque currently being supplied by the engine 200a (i.e. without torque intervention).
Whether the upper limit 550a of the fast torque of the engine exceeds a predetermined threshold percentage of the peak of the predicted torque intervention profile for fast torque actuation. (For example, if the predetermined threshold percentage of the peak of the predicted torque intervention profile is 80%, and if the upper limit 550a of the fast torque of the engine is greater than 80% of the peak of the predicted torque intervention profile).

If, in view of these parameters, the powertrain control module 110a determines in the arbitration of step 3300 that the fast torque of the engine 200a can deliver the requested increase in torque for the predicted torque intervention profile, then the powertrain control module 110a predicts the fast torque of the engine 200a as the actuator that will deliver the increase in torque requested in the torque intervention request.

For example, the powertrain control module 110a may determine that the engine 200a is currently assigned as the primary actuator and that an increase in torque is needed (i.e. the peak torque of the predicted torque intervention profile is greater than zero). The powertrain control module may then also determine, based on the current ambient pressure and engine speed, the torque currently being supplied by the engine 200a, the upper limit 550a for the fast torque of the engine 200a, the peak torque in the predicted torque profile, and whether the upper limit 550a exceeds the predetermined threshold percentage of the peak torque of the predicted torque intervention profile, that the fast torque of the engine 200a is able to supply the requested increase in torque for the torque intervention request.

The powertrain control module 110a may then output to the transmission control module 110b the fast torque of the engine 200a as being one of the predicted one or more torque actuators of the plurality of torque actuators 200 to be used in the torque intervention.

In some embodiments, this may take the form of setting a Boolean flag for the fast torque of the engine 200a, and providing the transmission control module 110b with that Boolean flag to identify the fast torque of the engine 200a as being the predicted torque actuator of the plurality of torque actuators 200 to be used in the torque intervention. Here, in such embodiments, it is noted that only one Boolean flag may be set at any one time.

If it is determined in step 3300 that the fast torque of the engine 200a cannot supply the requested torque for the torque intervention request, then the powertrain control module 110a does not predict the fast torque of the engine 200a as the actuator that will deliver the increase in torque requested in the torque intervention request.

If in step 3300 it is determined that the fast torque of the engine 200a cannot supply the requested torque for the torque intervention request, and where the engine 200a has a turbo, then the powertrain control module 110a proceeds to step 3350 and determine whether the slow torque of the engine 200a is able to supply the requested torque for the torque intervention request.

Here, at step 3350, the powertrain control module 110a determines whether all of the following requirements is the case:
The engine 200a is currently assigned to be the primary actuator.
The peak amount of torque of the predicted torque profile is greater than zero (in the same manner as determined from step 3250).
The upper limit 550a of the slow torque of the engine 200a is greater than the threshold for combined intervention (where multiple actuators of the plurality of actuators 200 are predicted to supply the torque requested in the torque intervention request).
The fast torque of the engine 200a has not been predicted as the actuator that will deliver the increase in torque requested in the torque intervention request.

If it is determined in step 3350 that each of the above requirements is met, then the powertrain control module 110a predicts the slow torque of the engine 200a as the actuator that will deliver the increase in torque requested in the torque intervention request.

For example, the powertrain control module 110a may determine that the engine 200a is currently assigned as the primary actuator and that an increase in torque is needed (i.e. the peak torque of the predicted torque intervention profile is greater than zero). The powertrain control module may also determine that the upper limit 550a of the slow torque of the engine 200a is greater than the threshold for combined intervention (where multiple actuators of the plurality of actuators 200 are predicted to supply the torque requested in the torque intervention request), and therefore that the slow torque of the engine 200a can supply the increase in torque requested in the torque intervention request.

The powertrain control module 110a may then output to the transmission control module 110b the slow torque of the engine 200a as being one of the predicted one or more torque actuators of the plurality of torque actuators 200 to be used in the torque intervention.

In some embodiments, this may take the form of setting a Boolean flag for the slow torque of the engine 200a, and providing the transmission control module 110b with that Boolean flag to identify the slow torque of the engine 200a as being the predicted torque actuator of the plurality of torque actuators 200 to be used in the torque intervention. Here, in such embodiments, it is noted that only one Boolean flag may be set at any one time.

If it is determined in step 3350 that the slow toque of the engine 200a cannot supply the requested torque for the torque intervention request, then the powertrain control module 110a does not predict the slow torque of the engine 200a as the actuator that will deliver the torque requested in the torque intervention request.

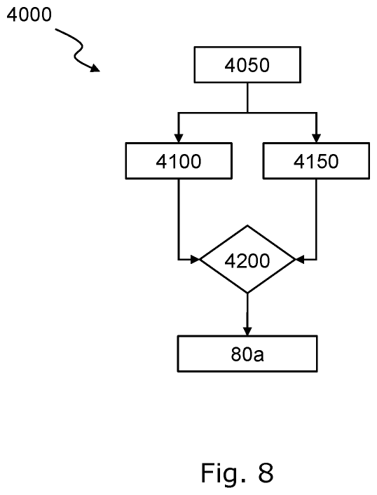

FIG. 8 shows a method 4000 according to some embodiments in which the powertrain control module 110a determines whether a combined intervention is necessary. Here, a combined intervention is understood to be a scenario where multiple actuators of the plurality of actuators 200 are predicted to supply the torque requested in the torque intervention request. In some embodiments, the method 4000 may be carried out after the preceding methods 1000, 2000, and 3000 (or their appropriate equivalents) have been carried out.

The method 4000 of FIG. 8 may be carried out after a request for torque intervention has been received, but before it has been implemented. This may, for example, correspond with time t=a, or just prior to time t=a in FIG. 4.

At step 4050, the powertrain control module 110a determines that none of the actuators of the plurality of actuators 200 have been individually predicted as being able to supply the torque for the torque intervention request. That is to say, and with reference to the methods of each of FIGS. 5 to 7, the powertrain control module 110a determines that none of the electric machine 200b, the fast torque of the engine 200a, the slow torque of the engine 200a, or the engine ignition of the engine 200a (or, in the case of a diesel engine, the diesel engine 200a) are able to solely (i.e. on their own) supply the torque for the torque intervention request.

In some embodiments, this may mean that none of the Boolean flags associated with the electric machine 200b, the fast torque of the engine 200a, the slow torque of the engine 200a, or the engine ignition of the engine 200a (or, in the case of a diesel engine, the diesel engine 200a) have been set.

Then, at step 4100, the powertrain control module 110a determines whether the upper limit 550a or the lower limit 550b (depending on whether an increase or decrease in torque is required in the torque intervention request) of the currently assigned primary torque actuator is less than the predetermined threshold percentage of the peak of the predicted torque profile for combined intervention. The currently assigned primary actuator may for example be the engine 200a or the electric machine 200b, or may be any other suitable actuator of the plurality of actuators 200.

For example, where the currently assigned primary actuator is the engine 200a and where the predetermined threshold for combined intervention is 70% of the peak of the predicted torque profile, the powertrain control module 110a may determine that the upper limit 550a of the currently available torque that can be supplied by the engine 200a is 60% of the peak of the predicted torque profile (i.e. is less than that threshold).

Then, at step 4150, the powertrain control module 110a determines whether the upper limit 550a or the lower limit 550b (depending on whether an increase or decrease in torque is required in the torque intervention request) of the currently assigned secondary torque actuator is greater than the predetermined low contribution threshold percentage of the peak of the predicted torque profile. Here, the currently assigned secondary actuator may for example be whichever of the engine 200a or the electric machine 200b that is not currently assigned as the primary actuator. Alternatively, the currently assigned secondary actuator may be any other suitable actuator of the plurality of actuators 200.

For example, where the currently assigned secondary actuator is the electric machine 200b and where the predetermined low contribution threshold is 20% of the peak of the predicted torque profile, the powertrain control module 110a may determine that the upper limit 550a of the currently available torque that can be supplied by the electric machine 200b is 40% of the peak of the predicted torque profile (i.e. is greater than that threshold).

If the determination of step 4100 is that the primary actuator can only supply torque below the predetermined threshold for combined intervention, and if the determination of step 4150 is that the secondary actuator can supply torque above the predetermined low contribution threshold, then the powertrain control module 110a determines in step 4200 a combination of the primary and second actuators to deliver the torque requested in the torque intervention request.

For example, the powertrain control module 110a may determine in step 4200 the torque requested in the torque intervention request can at least partially be supplied by a combination of the fast torque of the engine 200a and the electric machine 200b.

The specific combination of actuators, and the weighting of those actuators, in the determination in step 4200 may be dependent upon the upper limit 550a and lower limit 550b of each relevant actuator, as well as the speed at which the requested torque can currently be supplied.

The powertrain control module 110a may then output to the transmission control module 110b the determined combination of actuators as the predicted one or more torque actuators of the plurality of torque actuators 200 to be used in the torque intervention.

In some embodiments, this may take the form of setting a Boolean flag for a combined intervention, and providing the transmission control module 110b with that Boolean flag to identify a combination of actuators of the plurality of torque actuators 200 as being predicted to be used in the torque intervention.

As discussed above with reference to the methods of FIGS. 5 to 8, the transmission control module 110b may receive the predicted one or more actuators from the powertrain control module 110a. In some embodiments, the predicted one or more actuators may be received by the transmission control module 110b in the form of a binary flag or signal.

In some embodiments, the predicted one or more actuators may be in the form of a Boolean flag. For example, and with reference to the specific methods of FIGS. 5 to 8, the transmission control module 110b may receive from the powertrain control module 110a one of: a Boolean flag for the electric machine 200b, a Boolean flag for the ignition of the engine 200a (or, in the case of a diesel engine, the diesel engine 200a), a Boolean flag for the fast torque of the engine 200a, a Boolean flag for the slow torque of the engine 200a, or a Boolean flag for combined intervention. Here, it is noted that only one Boolean flag may be set at any one time.

In some embodiments, after receiving the predicted one or more actuators from the powertrain control module 110a, the transmission control module 110b may then adjust the torque intervention request based on the predicted one or more actuators. For example, the transmission control module 110b may adjust the torque intervention request such that the predicted one or more actuators is better able to supply the requested torque for that torque intervention request. This then improves the quality of the torque intervention request (e.g. a smoother gear shift), and therefore maintains the drivability of the vehicle 10.

In some embodiments, after receiving the predicted one or more actuators from the powertrain control module 110a, the transmission control module 110b may adjust the torque intervention request by modifying one or both of the timing and amplitude of the torque intervention request based on the predicted one or more actuators.

For example, in a scenario in which the slow torque of the engine 200a is predicted to be the one or more actuators for the torque intervention, the transmission control module 110b may modify the timing of the torque intervention request such that the slow torque of the engine 200a is better able to meet that torque intervention request and the quality of the torque intervention is improved.

As a further example, in a scenario in which the electric machine 200b is predicted to be the one or more actuators for the torque intervention, the transmission control module 110b may reduce the amplitude of the torque intervention request such that the electric machine 200b is better able to supply that reduced amount of torque to meet that torque intervention request. As a result, the quality of the torque intervention is improved and the drivability of the vehicle 10 is maintained.

FIG. 9 shows a flowchart of a method 5000 of the function of the control system 100 according to some embodiments. In particular, the method 5000 of FIG. 9 is a method of operating a control system 100 of a vehicle 10 for managing the torque of the vehicle 10. The method 5000 may be performed by the control system 100 as illustrated in FIG. 9. In particular, the memory 130 may comprise computer-readable instructions which, when executed by the processor 112, perform the method 5000 according to an embodiment of the invention.

At step 5050, during a predetermined time period, torque availability data 500 is collected from each actuator of the plurality of actuators 200 of the powertrain 400 (or propulsion system, or power source).

At step 5100, the torque availability data 500 is then provided to the powertrain control module 110a. The torque availability data 500 received at the powertrain control module 110a is therefore representative of the amount of torque available for supply by each actuator of the plurality of actuators 200 of the powertrain 400 of the vehicle 10 within the predetermined time period. It will be understood that the powertrain control module 110a may also be referred to as the first control module. It will also be understood that the powertrain control module 110a may form part of one or more controllers 115 of the control system 100.

At step 5150, the powertrain control module 110a (or first control module) may optionally calculate at least one of the upper limit 550a and the lower limit 550b of the torque available for torque intervention for each actuator of the plurality of actuators 200 during the predetermined time period based on the torque availability data 500.

At step 5200, the powertrain control module 110a receives a torque intervention request from the transmission control module 110b. It will be understood that the transmission control module 110b may also be referred to as the second control module. It will also be understood that the transmission control module 110b may form part of the one or more controllers 115 of the control system 100.

At step 5250, the powertrain control module 110a generates a predicted torque profile of the torque intervention request. It will be understood that, in some embodiments, the transmission control module 110b may alternatively generate the predicted torque profile of the torque intervention request and provide that precited torque profile to the powertrain control module 110a (instead of, or in addition to, providing the torque intervention request of step 5200). Furthermore, and as discussed above, it will also be understood that, in some embodiments, the torque intervention request may be a predicted torque intervention request. That is to say, and as discussed above, the received torque intervention request may not be a “real” torque intervention request, and may instead be a predicted torque intervention request generated to ideally match a real torque intervention request received (or generated in response to receiving a signal indicating a torque intervention, such as a gear shift) at a later time.

At step 5300, the powertrain control module 110a predicts one or more torque actuators of the plurality of torque actuators 200 that will be used in the torque intervention during the predetermined time period. The prediction of the one or more torque actuators is based upon the predicted torque profile and the torque availability data of each of the one or more torque actuators. In some embodiments, and where option step 5150 is performed, the prediction of the one or more torque actuators is based upon the at least one of the upper limit 550a and the lower limit 550b calculated for each actuator of the plurality of actuators 200.

At step 5350, the powertrain control module 110a outputs the predicted one or more torque actuators of the plurality of torque actuators 200 that will be used in the torque intervention during the predetermined time period to the transmission control module 110b.

In some embodiments, the following steps from step 5400 onwards may be considered optional. At step 5400, the transmission control module 110b adjusts the torque intervention request based upon the received predicted one or more torque actuators of the plurality of torque actuators 200.

At step 5450, the transmission control module 110b implements the adjusted torque intervention request to increase or decrease the torque supplied by the powertrain 400 of the vehicle 10 during the predetermined time period.

Therefore, the torque intervention request is adjusted and implemented based upon the predicted one or more actuators of the plurality of actuators 200 that will provide the torque for that torque intervention request. As a result, since the adjusted torque intervention request is tailored to the predicted one or more actuators of the powertrain 400 that will supply the required torque for that torque intervention request, the control and quality of the resulting torque intervention (e.g. gear shift) is improved, thereby improving the overall drivability of the vehicle 10.

As discussed above, it will be appreciated that the term upper limit may also be understood to be an upper threshold. Likewise, it will be appreciated that the term lower limit may also be understood to be a lower threshold.

As discussed above, FIGS. 5 to 9 illustrate methods 1000, 2000, 3000, 4000, and 5000 described by flow charts 1000, 2000, 3000, 4000, and 5000 according to one or more embodiments of the invention. The methods 1000, 2000, 3000, and 4000 are methods for predicting one or more actuators of the powertrain 400 for supplying torque to implement a received torque intervention request in a vehicle 10, such as the vehicle 10 illustrated in FIG. 1. The method 5000 is a method for managing the torque supplied by the powertrain 400 of a vehicle 10 by predicting one or more actuators of the powertrain 400 for supplying torque to implement a received torque intervention request in the vehicle 10, such as the vehicle 10 illustrated in FIG. 1.

The methods 1000, 2000, 3000, 4000, and 5000 may be performed by the control system 100 illustrated in FIG. 3. In particular, the memory 130 may comprise computer-readable instructions which, when executed by the processor 110, perform one or more of the methods 1000, 2000, 3000, 4000, and 5000 according to one or more embodiments of the invention.

It will be appreciated that various changes and modifications can be made to the present invention without departing from the scope of the present application.

For purposes of this disclosure, it is to be understood that reference to ‘the control system being configured to’ is to be understood to mean ‘the one or more controllers of the control system are collectively configured to’. The controller(s) described herein can each comprise a control unit or computational device having one or more electronic processors, the one or more processors collectively configured to perform the control system functionality set out in the control system claims.

For purposes of the disclosure, the following can be used to label the figures:

| | | |
|---|---|---|
| FIG. 5 | 51a | Electric Machine |
| FIG. 6 | 60a | Engine Ignition/Diesel Engine |
| FIG. 7 | 70a | Engine Fast Torque |
| FIG. 7 | 71a | Engine Slow Torque |
| FIG. 8 | 80a | Combined Intervention |

1. A control system for managing the torque of a vehicle, the control system comprising one or more controllers, and wherein the control system is configured to:
receive, at the one or more controllers, current torque availability data for each of a plurality of torque actuators of a propulsion system of the vehicle, the torque availability data representative of an amount of torque available for supply by the respective torque actuator of the propulsion system of the vehicle within a predetermined time period;
receive, at the one or more controllers, a torque intervention request to either increase or decrease the torque supplied by the propulsion system of the vehicle during the predetermined time period;
generate, by the one or more controllers, a predicted torque profile of the torque intervention request;
predict, by the one or more controllers, one or more torque actuators of the plurality of torque actuators to be used in the torque intervention during the predetermined time period, the prediction being based upon the predicted torque profile and the torque availability data of each of the one or more torque actuators;
adjust, by the one or more controllers, the torque intervention request based upon the predicted one or more torque actuators of the plurality of torque actuators; and
implement, by the one or more controllers, the adjusted torque intervention request to increase or decrease the torque supplied by the propulsion system of the vehicle during the predetermined time period.

2. The control system of claim 1, wherein the one or more controllers comprises a first control module and a second control module, and wherein:
the first control module is configured to receive the torque availability data and the torque intervention request, generate the predicted torque profile of the torque intervention request; and predict the one or more torque actuators of the plurality of torque actuators based on the predicted torque profile and the torque availability data of each of the one or more torque actuators; and
the second control module is configured to adjust the torque intervention request based upon the predicted one or more torque actuators, and implement the adjusted torque intervention request.

3. The control system of claim 2, wherein the torque availability data for each of the plurality of torque actuators comprises at least one of an upper limit of the torque available that can be supplied by each of the plurality of torque actuators during the predetermined time period, and a lower limit of the torque available that can be supplied by each of the plurality of torque actuators during the predetermined time period.

4. The control system of claim 3, wherein:
predicting the one or more torque actuators of the plurality of torque actuators comprises determining, for each of the one or more torque actuators, that the predicted torque profile is at least one of:
less than the upper limit of the torque available during the predetermined time period; and
greater than the lower limit of the torque available during the predetermined time period.

5. The control system of claim 2, wherein the:
predicting the one or more torque actuators of the plurality of torque actuators comprises determining, for each of the one or more torque actuators, that the predicted torque profile is at least one of:
greater than the upper limit of the torque available during the predetermined time period by less than a predetermined relative amount, or
less than the lower limit of the torque available during the predetermined time period by less than a predetermined relative amount.

6. The control system of claim 2, wherein:
predicting, by the first control module, the one or more torque actuators of the plurality of torque actuators comprises one of:
determining that the predicted torque profile is greater than the upper limit of the torque available during the predetermined time period for a first torque actuator of the plurality of torque actuators;
determining that a sum of the upper limit of the torque available during the predetermined time period for the first torque actuator and the upper limit of the torque available during the predetermined time period for a second torque actuator of the plurality of torque actuators of the plurality of torque actuators is greater than the predicted torque profile; and
predicting the first and second torque actuators as the predicted one or more torque actuators; or
determining that the predicted torque profile is less than the lower limit of the torque available during the predetermined time period for a first torque actuator of the plurality of torque actuators;
determining that the sum of the lower limit of the torque available during the predetermined time period for the first torque actuator and the lower limit of the torque available during the predetermined time period for a second torque actuator of the plurality of torque actuators of the plurality of torque actuators is less than the predicted torque profile; and
predicting the first and second torque actuators as the predicted one or more torque actuators.

7. The control system of claim 2 wherein:
predicting the one or more torque actuators of the plurality of torque actuators comprises assigning a value for each torque actuator of the plurality of torque actuators based on the amount of torque available for supply within the predetermined time period for that torque actuator and the predicted torque profile, and
wherein the predicted one or more torque actuators of the plurality of torque actuators comprises the assigned value for each of the predicted one or more torque actuators, and the adjusting of the torque intervention request is based upon the assigned value of each of the predicted one or more torque actuators of the plurality of torque actuators.

8. The control system of claim 2, wherein the plurality of torque actuators comprises at least one of:
an electric motor of the vehicle;
an engine ignition of the vehicle;
a fast torque delivery actuator of the engine; and
a slow torque delivery actuator of the engine.

9. The control system of claim 2, wherein the adjusting of the torque intervention request comprises adjusting one or more of a timing and an amplitude of the torque intervention request based upon the predicted one or more torque actuators for the requested torque intervention.

10. A vehicle comprising the control system of claim 1.

11. A method of managing the torque of a vehicle, the method comprising:
receiving current torque availability data for each of a plurality of torque actuators of a propulsion system of the vehicle, the torque availability data representative of an amount of torque available for supply by the respective torque actuator of the propulsion system of the vehicle within a predetermined time period;
receiving a torque intervention request to either increase or decrease the torque supplied by the propulsion system of the vehicle during the predetermined time period;
generating a predicted torque profile of the torque intervention request;
predicting one or more torque actuators of the plurality of torque actuators for use in a torque intervention during the predetermined time period, the prediction based upon the predicted torque profile and the torque availability data of each of the one or more torque actuators;
adjusting the torque intervention request based upon the predicted one or more torque actuators of the plurality of torque actuators; and
implementing the adjusted torque intervention request to increase or decrease the torque supplied by the propulsion system of the vehicle during the predetermined time period.

12. The method of claim 11, wherein the adjusting of the torque intervention request comprises adjusting one or more of a timing and an amplitude of the torque intervention request based upon the one or more torque actuators for the requested torque intervention.

13. Computer readable instructions which, when executed by a computer, are arranged to perform a method according to claim 11.
